(19) United States
(12) Patent Application Publication
(10) Pub. No.: US 2003/0235716 A1
(43) Pub. Date: Dec. 25, 2003

(54) Method of producing NiFe alloy films having magnetic anisotropy and magnetic storage media including such films

(75) Inventors: Jai-Young Kim, Sewickley, PA (US); Xiaowei Wu, Pittsburgh, PA (US)

Correspondence Address: Robert P. Lenart, Pietragallo, Bosick & Gordon, One Oxford Centre, 38th Floor, 301 Grant Street, Pittsburgh, PA, 15219, US

(73) Assignee: Seagate Technology LLC, Scotts Valley, CA

(21) Appl. No.: 10/255,256

(22) Filed: Sep. 26, 2002

Related U.S. Application Data
(60) Provisional application No. 60/390,849, filed on Jun. 21, 2002.

(51) Int. Cl. B32B 3/00

(52) U.S. Cl. 428/694 TM; 428/694 R

(57) ABSTRACT

A method of fabricating anisotropic magnetic films includes providing a substrate, sputtering a layer of NiₓFe_{y} (where x ranges from 40 to 50 and y=(100-x)) onto a surface of the substrate, and subjecting the layer of NiₓFe_{y} to a rotating magnetic field during the sputtering deposition process. A magnetic storage medium comprising a substrate, a soft magnetic underlayer supported by the substrate, the soft magnetic underlayer including NiₓFe_{y} (where x ranges from 40 to 50 and y=(100-x)) and having an easy axis in a circumferential direction and a hard axis in a radial direction, and a magnetically hard recording layer supported by the soft magnetic underlayer, is also included.

### CROSS REFERENCE TO RELATED APPLICATION

This application claims the benefit of U.S. Provisional Patent Application Serial No. 60/390,849, filed Jun. 21, 2002.

### FIELD OF THE INVENTION

This invention relates to methods for producing NiFe films having magnetic anisotropy, and more particularly to the use of such methods in the manufacture of magnetic storage media, and magnetic storage media including such films.

### BACKGROUND OF THE INVENTION

To increase the areal recording densities in both longitudinal and perpendicular magnetic information data storage media, a reduction in the recording film thickness is desirable. Films with reduced thickness minimize the transition parameter (a) between recorded bit patterns. The transition parameter (a) can be defined as shown in Equation 1:

a=(M_{rd} δd_{eff}/H_{c})^{1/2} (Equation 1)

where, Mᵣ is the remanent magnetization of the recording film; δ is the recording film thickness; d_{eff} is the effective head-to-media spacing (magnetic spacing) [d_{eff}={d(d+δ/2)}^{1/2}, where d is the head-to-media spacing]; and H_{c} is the coercivity of the recording film.

As the film thickness is reduced for narrow transition parameters in both longitudinal and perpendicular recording films, the magnetic volume energy (Kᵤ×V) of magnetic grains in the films can be less than the thermal fluctuation energy (k_{B}×T) of the magnetic recording media, which limits storage density due to superparamagnetic effects. The magnetic energy should be larger than the thermal fluctuation energy to safely store information in the recorded magnetic bit pattern. This can be expressed as:

(Kᵤ×V)>(k_{B}×T) (Equation 2)

where, Kᵤ is the magnetic anisotropy energy of a magnetic grain; V is the magnetic grain volume; k_{B} is Boltzman's constant; and T is the absolute temperature.

In terms of the thermal stability, perpendicular magnetic recording media is superior to longitudinal magnetic recording media due to a larger magnetic volume energy.

To store a bit pattern in perpendicular magnetic recording media, the vector components of an applied magnetic recording field produced by a magnetic recording head should be perpendicular to the media film surface and parallel to the magnetic moments in the perpendicular media. In magnetic media having a single layer of magnetic material, a large demagnetization field opposing the recording head field has been observed, so that the head field cannot saturate the perpendicular recording media. This results from the lack of a closed magnetic field loop between the perpendicular head field and the media magnetic moments. To solve the demagnetization field issue in a perpendicular recording system, magnetic soft underlayer films have been suggested beneath the perpendicular recording media film to form the closed magnetic field loop.

Recording media films with high coercivity and a soft underlayer film that can support a large magnetic flux are required to increase the areal recording density in perpendicular magnetic recording. A magnetic anisotropy free Permalloy film (Ni₈₀Fe₂₀) with zero magneto-crystalline anisotropy energy and magnetostriction constant has been used as a soft underlayer film in a perpendicular magnetic recording disc. But the Permalloy film cannot support the large magnetic flux, because the saturation magnetic flux of the film is less than 1 Tesla.

The soft underlayer films must not only support the large magnetic flux used to write data to the media, but must also exhibit low transition noise for reading performance. The major source of transition noise is attributed to the magnetic isotropy in the magnetic domain boundaries between recorded bit patterns during the readout process. To minimize transition noise in the readout signal, preferential magnetic anisotropy energy along the circumferential direction on the surface of the soft underlayer film should be enhanced, and magnetic anisotropy energy along the radial direction on the surface of the soft underlayer film should be suppressed. This can be achieved by using a film having a large magnetic anisotropy field (Hₖ). However, the Permalloy film does not possess a large Hₖ, due to its isotropic magnetic characteristics.

Moreover, because promising perpendicular magnetic recording films for high areal recording density, such as CoCr based alloy film and ordered FCT (Face Center Tetragonal) L1o based intermetallic compound films require high annealing temperatures to obtain large coercivity in the films, a crystalline structure film is preferred to an amorphous structure film as the magnetic soft underlayer film in perpendicular recording discs.

There is a need for magnetic storage media that can store data that can be read with less transition noise than with previous storage media. In addition, to support high areal recording density media in perpendicular recording, a soft underlayer film with sufficient magnetic flux, a large magnetic anisotropy field and a stable crystalline structure is desired.

### SUMMARY OF THE INVENTION

This invention provides a method of fabricating anisotropic magnetic films including: providing a substrate, sputtering a layer of NiₓFe_{y} (where x ranges from 40 to 50 and y=(100-x)) onto a surface of the substrate, and subjecting the layer of NiₓFe_{y} to a rotating magnetic field during the sputtering deposition process.

The layer of NiₓFe_{y} can have a magnetostriction constant in the range of 5×10⁻⁶ to 25×10⁻⁶. The sputtering pressure can be in the range of 3 to 8 mTorr. The layer of NiₓFe_{y} can have a thickness in the range of 200-400 nm.

The step of subjecting the layer of NiₓFe_{y} to a rotating magnetic field during the sputtering deposition process can include positioning a first magnet above the layer of NiₓFe_{y} and rotating the first magnet during the sputtering deposition process, and can further include positioning a second magnet below the layer of NiₓFe_{y} and rotating the second magnet during the sputtering deposition process. The substrate can include a material selected from the group of glass, MgO, silicon, and aluminum alloys.

The method can further include controlling the sputtering pressure and thickness of the layer of NiₓFe_{y} to control the magnetic anisotropy of the layer of NiₓFe_{y}.

The invention also encompasses a magnetic storage medium comprising a substrate, a soft magnetic underlayer supported by the substrate, the soft magnetic underlayer including NiₓFe_{y} (where x ranges from 40 to 50 and y=(100-x)) and having an easy magnetic axis in a circumferential direction and a hard magnetic axis in a radial direction, and a magnetically hard recording layer supported by the soft magnetic underlayer. The soft magnetic underlayer can have a magnetic anisotropy field (Hₖ) of greater than 50 Oe to reduce the transition noise in the recording layer.

### BRIEF DESCRIPTION OF THE DRAWINGS

FIG. 1 is a schematic representation of a sputtering system that can be used to perform the method of the invention.

FIG. 2 is a graph showing magnetic hysteresis loops measured in circumferential and radial directions on the surface of the film made in accordance with the invention.

FIG. 3 is a graph showing the magnetic anisotropy field (Hₖ), circumferential coercivity (H_{cc}), radial coercivity (H_{cr}) and (111) diffraction peak positions of NiFe alloy films deposited with no externally applied rotational magnetic field as the function of a sputtering deposition pressure.

FIG. 4 is a graph showing the magnetic anisotropy field (Hₖ), circumferential coercivity (H_{cc}), radial coercivity (H_{cr}) and (111) diffraction peak positions of NiFe alloy films deposited under an externally applied rotational magnetic field as the function of a sputtering deposition pressure.

FIG. 5 is a graph showing the magnetic anisotropy field (Hₖ), circumferential coercivity (H_{cc}), radial coercivity (H_{cr}) and (111) diffraction peak positions of NiFe alloy films deposited at 5 mTorr as the function of a externally applied rotational magnetic field during the film deposition.

FIG. 6 is a schematic diagram illustrating the design of an experiment that demonstrates the inventive concepts.

FIG. 7 is a graph showing the magnetic anisotropy field (Hₖ), circumferential magnetic coercivity (H_{cc}) and radial magnetic coercivity (H_{cr}) of several Ni 40-50 at. %—Fe alloy films.

FIG. 8 is a graph showing the statistical analysis of the effects of film thickness, sputtering power and bias voltage on magnetic anisotropy field (Hₖ) in NiFe alloy films.

FIG. 9 is a graph showing the sputtering power effect on magnetic anisotropy field (Hₖ), circumferential coercivity (H_{cc}) and radial coercivity (Hcr) in NiFe alloy films.

FIG. 10 is a graph showing the bias voltage effect on magnetic anisotropy field (Hₖ), circumferential coercivity (H_{cc}) and radial coercivity (H_{cr}) in NiFe alloy films as a function of bias voltage.

FIG. 11 is a graph showing magnetic anisotropy field (Hₖ) in NiFe alloy films as the function of the film thickness.

FIG. 12 is a cross-section of a portion of a magnetic storage medium constructed in accordance with the invention, in combination with a perpendicular recording head.

FIG. 13 is a plan view of a portion of a magnetic film constructed in accordance with the invention.

### DETAILED DESCRIPTION OF THE INVENTION

To obtain a large magnetic anisotropy field (Hₖ) in a magnetic soft underlayer film for the suppression of a transition noise during a read-out signal process in perpendicular recording, preferential magnetic anisotropy energy on the surface of the film (also called the easy axis) should lie along the circumferential direction and the hard axis should lie along the radial direction. The magnetic anisotropy energy in the soft magnetic underlayer film can be described as follows:

K_{eff}=K_{mc}+Kₘₑ−Kₘₛ (Equation 3)

where, K_{eff} is the effective in-plane magnetic anisotropy energy; K_{mc} is the magneto-crystalline anisotropy energy; Kₘₑ is the magneto-elastic anisotropy energy (where Kₘₑ=−3/2λₛσ, with λₛ being the saturation magnetostriction constant, and σ being the residual stress); and Kₘₛ is the magneto-static anisotropy energy (Kₘₛ=2πN_{d}Mₛ², where N_{d} is the demagnetization factor, and Mₛ is the saturation magnetization).

Ni₈₀Fe₂₀ Permalloy film has been previously suggested for use in a magnetically soft underlayer film in perpendicular magnetic storage media. Because both the magnetocrystalline anisotropy and the magnetostriction constants in a Ni₈₀Fe₂₀ Pernalloy film are close to zero, K_{mc} and Kₘₑ should be zero. Moreover, since the demagnetization factor (N_{d}) on the thin film surface is infinitely small, Kₘₛ of the film can be minimized when the magnetic moments randomly lie on the surface. This means that the magnetic moments of the Permnalloy film are randomly distributed on the surface of the film without any preferred magnetic orientations, which results in null Hₖ.

In the previous work, directional atomic pair ordering in Ni and Fe moments parallel to a magnetic field direction have been created in the Permalloy films, by cooling the films in a magnetic field. The induced magnetic anisotropy energy resulting from the directional ordering was in the range of 1×10³ ergs/cm³ to 2×10³ ergs/cm³, which provided an Hₖ of less than 10 Oe. This level of Hₖ cannot sufficiently suppress the transition noise in the soft underlayer films of perpendicular recording media.

For this invention, a NiFe alloy film in which Ni is in the range of 40 to 50 atomic percent, is used as a soft underlayer film for a perpendicular magnetic recording disc. Because the NiFe alloy film has a saturation magnetic flux in the range of 1.5-1.7 Tesla, the issue of enhanced magnetic flux from the soft underlayer film can be neglected, compared with that in the previously used Permalloy film. The method of this invention obtains a large magnetic anisotropy field (Hₖ) in the soft underlayer film of NiFe by depositing the film in the presence of a rotating magnetic field.

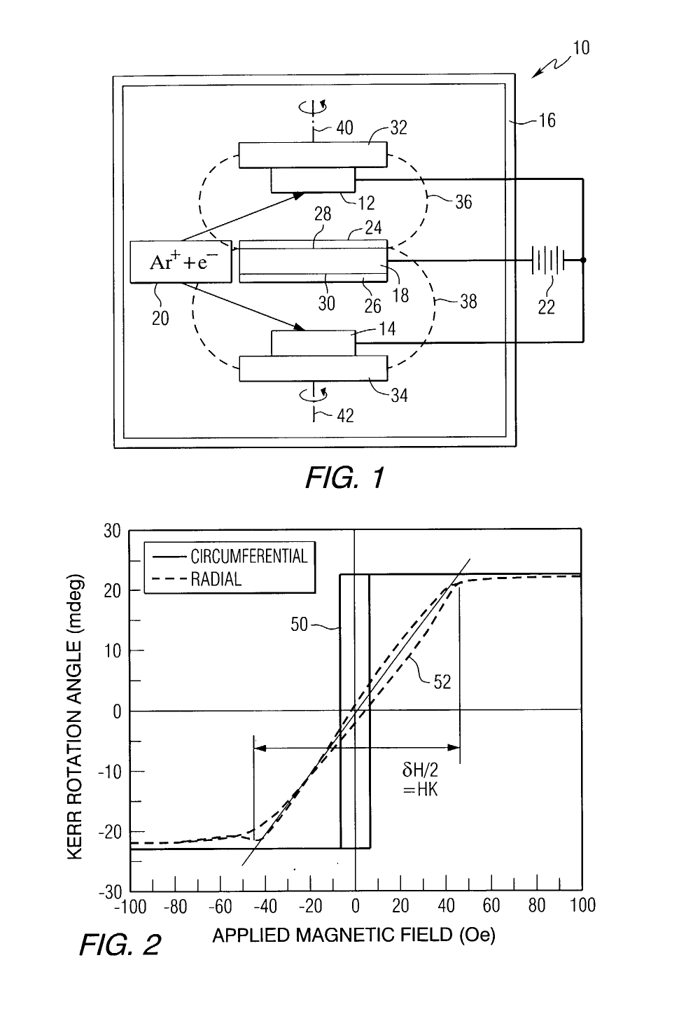

FIG. 1 is a schematic representation of a sputtering system 10 that can be used to practice the invention. The system includes first and second NiFe targets 12 and 14 in a sputtering chamber 16. The NiFe targets include a NiFe alloy wherein Ni is between 40 and 50 atomic weight percent of the alloy (e.g. NiₓFe_{y}, where x ranges from 40 to 50 and y =(100-x)). A substrate 18 is positioned between the targets and the targets are bombarded by Ar ions from an ion source 20. This dislodges NiFe particles from the targets. The particles are attracted to the substrate due to a voltage applied between the targets and the substrate by voltage source 22. The particles form films 24 and 26 on surfaces 28 and 30 of the substrate. Magnets 32 and 34 are positioned such that the films are subjected to magnetic fields 36 and 38 produced by the magnets. During deposition of the films, the magnets are rotated around axes 40 and 42, thereby subjecting the films to a rotating magnetic field. The magnetic field can be created by placing a plurality of permanent magnets in a circular array on a disc and rotating the disc. The energy product (BHₘₐₓ) of the permanent magnets should be larger than 10 MGOe to provide sufficient magnetic flux to the films during the sputtering deposition process. In one example sputtering system, ten magnets were arranged on a circular array on a rotatable plate that was positioned 50 mm from the film.

Film can be deposited using either the upper or lower magnet, or both, to provide the external magnetic field. If both magnets are used, they would be rotated in the same direction.

Ni (40-50 at. %)—Fe alloy film has a magnetocrystalline anisotropy constant K_{mc} of almost zero at these compositions, due to the mixture of fine crystalline grains at the boundary of FCC and BCC structures. Therefore, K_{mc} in Equation 3 does not contribute to the formation of preferred magnetic anisotropy along the circumferential direction. Also the magneto-static anisotropy energy Kₘₛ in the NiFe film indicates that the magnetic moment is randomly distributed on the film surface.

A significant difference in Ni (40-50 at. %)—Fe alloy films compared with previously used Ni₈₀Fe₂₀ Permalloy film is the existence of saturation magnetostriction constants (λ_{S}) in the range of 10×10⁻⁶ to 20×10⁻⁶, which can create Kₘₑ by combining with residual stress. When compressive residual stress is formed on the surface of the film, it gives rise to the preferential magnetic anisotropy on the surface of the film. The anisotropy is randomly distributed along with the micro stress distribution directions. However, when the compressive residual stress is formed along with circumferentially induced atomic pair ordering, the magnetic moments of the NiFe alloy film preferentially lie along the circumferential direction on the surface of the film. This is caused by the combined effect of the induced directional atomic pair ordering anisotropy energy and the magneto-elastic anisotropy energy. This results in an increase of preferred magnetic anisotropy energy along the circumferential direction of the NiFe film and of the hard magnetic anisotropy energy in the radial direction as well.

To verify the invention concept, Ni (40-50 at. %)—Fe alloy films were deposited on a glass substrate in an Ar gas atmosphere of a DC magnetron sputtering system. The induced directional atomic pair ordering magnetic anisotropy energy and magneto-elastic anisotropy energy caused changes in the magnetic anisotropy field (Hₖ) of the films. The amount of magnetic anisotropy can be controlled by controlling the externally applied rotational magnetic field, sputtering gas pressure, sputtering power, bias voltage and NiFe film thickness during the film deposition. Crystallographic diffraction patterns of the films were created by scanning with an X-ray diffractometer having a Cu Kαλ filter (λ=0.15406 nm). Magnetic hysteresis loops in circumferential and radial directions on the surface of the film were measured by an in-plane Kerr magnetometer for up to 300 Oe of external magnetic field.

FIG. 2 is a graph showing magnetic hysteresis loops measured in circumferential and radial directions on the surface of an Ni (40-50 at. %)—Fe alloy film made in accordance with the invention. Loop 50 represents the circumferential direction and loop 52 represents the radial direction on the surface of the film. FIG. 2 also includes an estimation of the magnetic anisotropy field (Hₖ) for the film. The anisotropy field (Hₖ) of the NiFe film was estimated as shown in FIG. 2. Because the NiFe alloy film does not show uniaxial anisotropy energy, the Hₖ of the film can be obtained from the intersection of the circumferential hysteresis loop with a linear bisector line parallel to the radial direction hysteresis loop.

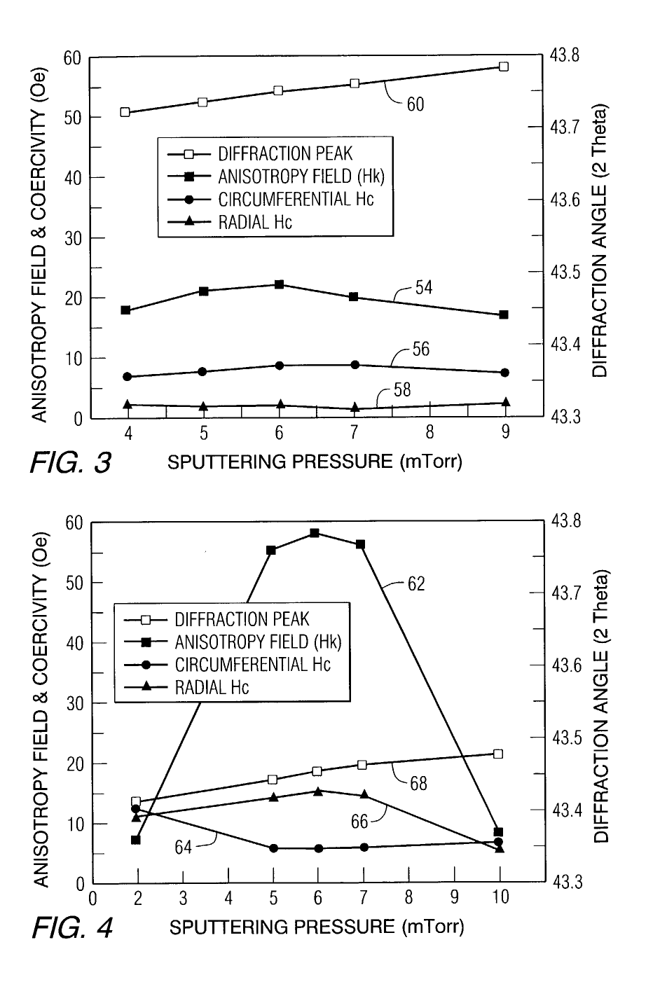

FIG. 3 is a graph showing the magnetic anisotropy field (Hₖ), circumferential coercivity (H_{cc}), radial coercivity (H_{cr}) and (111) diffraction peak positions of Ni (40-50 at. %)—Fe alloy films deposited with no externally applied rotational magnetic field as the function of sputtering deposition pressure. In FIG. 3, line 54 represents the magnetic anisotropy field (Hₖ), line 56 represents the circumferential coercivity (H_{cc}), line 58 represents the radial coercivity (H_{cr}) and line 60 represents the (111) diffraction peak positions. This figure shows that there is no significant change in Hₖ as a function of sputtering pressure when the external rotational magnetic field is not applied to the film during deposition. Because only the magneto-elastic energy in the film is changed by the variation of the sputtering pressure during deposition, the magnetic moments of the films are still distributed in random due to the lack of an induced directional atomic pair ordering anisotropy energy. This means that not only the magneto-elastic energy but also the induced directional atomic pair ordering anisotropy energy in the film should be simultaneously required to achieve preferential magnetic orientation in the circumstantial directions on the film surface.

FIG. 4 is a graph showing the magnetic anisotropy field (Hₖ), circumferential coercivity (H_{cc}), radial coercivity (H_{cr}) and (111) diffraction peak positions of NiFe alloy films deposited under an externally applied rotational magnetic field as the function of a sputtering deposition pressure. In FIG. 4, line 62 represents the magnetic anisotropy field (Hₖ), line 64 represents the circumferential coercivity (H_{cc}), line 66 represents the radial coercivity (H_{cr}) and line 68 represents the (111) diffraction peak positions of Ni (40-50 at. %)—Fe alloy films deposited under the externally applied rotational magnetic field as the function of sputtering deposition pressure. The anisotropy field represented by line 62 shows a significant increase at sputtering pressures of 4-7 mTorr. The energy product of the magnets can be in the range of 20 to 30 MGOe.

FIG. 3 and FIG. 4 show the magnetic anisotropy field (Hₖ), circumferential coercivity (H_{cc}), radial coercivity (H_{cr}) and (111) diffraction peak positions of Ni (40-50 at. %)—Fe alloy films deposited without and with externally applied rotational magnetic fields, respectively as the function of sputtering deposition pressure. The NiFe films on both of the figures show the (111) preferred texture film in X-ray diffraction curves.

The extrapolated linear equations for the (111) diffraction peaks derived from FIG. 3 and FIG. 4 are as follows

Position without the field=0.01246 (Sputtering pressure)+43.67535 (Equation 4)

Positions under the field=0.00816 (Sputtering pressure)+43.39841 (Equation 5)

When the NiFe films are deposited without any externally applied magnetic field as shown in FIG. 3, the extrapolated lattice parameter (a) of the film (a=3.586 Å) shows good agreement with that (a=3.585 Å) of equilibrium state bulk NiFe. However, when the external magnetic field is applied to the both sides of the film during the same deposition conditions shown in FIG. 4, the lattice distance (d111) in the (111) direction is expanded from 6.21 Å to 6.25 Å, respectively. This indicates that the application of the magnetic fields to the NiFe film creates tensile stress normal to the film plane which is proportional to the product of its elastic strain constant (=6.12×10⁻³) and its Young's modulus in (111) direction. The tensile stress perpendicular to the film plane causes the compressive stress on the film surface in the elastic deformation region.

In terms of Hₖ without the magnetic field, the maximum Hₖ of around 20 Oe was obtained from the films deposited at pressures of 5-7 mTorr in which the radial direction is still an easy magnetic axis, based on the comparison of H_{cc} and H_{cr} of the films. This Hₖ was mainly caused by the sputtering pressure effect. In the case of the films deposited in the magnetic fields, Hₖ of the films at low (2 mTorr) and high (10 mTorr) pressures was less than 10 Oe which is in good agreement with previous work relating to directional atomic pair ordering. But the Hₖ of the films deposited at intermediate pressures (5-7 mTorr) with the magnetic field shows a maximum Hₖ beyond 50 Oe. This indicates that the combination of the directional atomic pair ordering by the magnetic field and magneto-elastic anisotropy energy by the sputtering pressure of around 5-7 mTorr creates the large increase of Hₖ of more than 50 Oe. Under these conditions, the magnetic easy axis converts from the radial direction to the circumferential direction since the H_{cc} is less than H_{cr}.

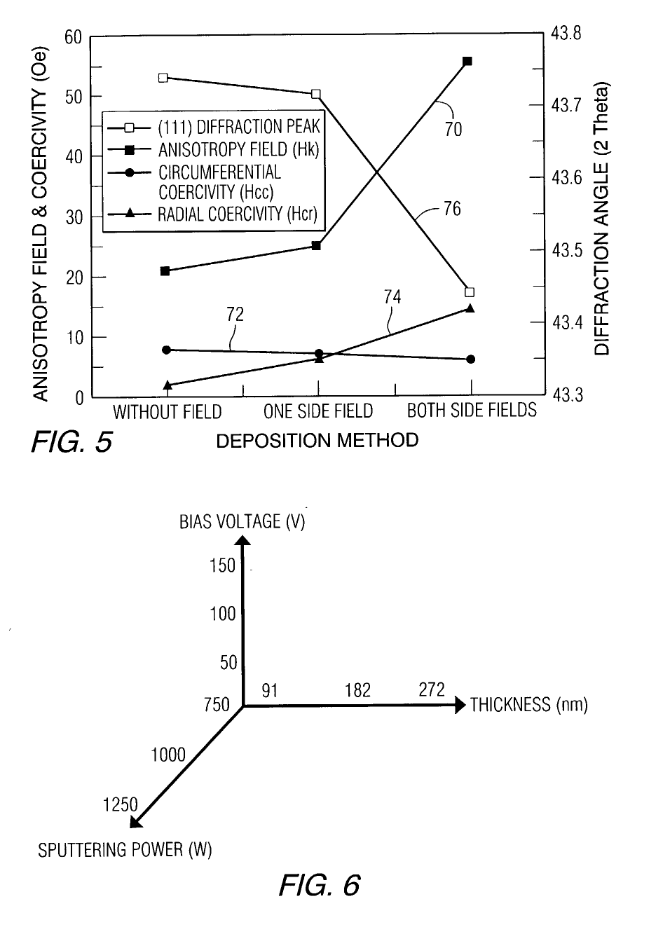

FIG. 5 is a graph showing the magnetic anisotropy field (Hₖ), circumferential coercivity (H_{cc}), radial coercivity (H_{cr}) and (111) diffraction peak positions of NiFe alloy films deposited at 5 mTorr as the function of an externally applied rotational magnetic field during the film deposition. In FIG. 5, line 70 represents the magnetic anisotropy field (Hₖ), line 72 represents circumferential coercivity (H_{cc}), line 74 represents radial coercivity (H_{cr}) and line 76 represents (111) diffraction peak positions of Ni (40-50 at. %)—Fe alloy films deposited at 5 mTorr as the function of an externally applied rotational magnetic field during the film deposition.

Because all the NiFe films used to obtain the data in FIG. 5 were deposited at 5 mTorr, the magnetoelastic effect by the sputtering pressure on Hₖ in the films is equivalently maximized as shown on FIG. 3 and FIG. 4. When the NiFe film is deposited without any magnetic field, the lattice parameter (a) of the film (a=3.582 Å) is close to that (a=3.585 Å) of equilibrium state bulk NiFe. The coercivity in the circumferential direction (H_{cc}) is larger than that in the radial direction (H_{cr}) so that a magnetic easy axis on the surface of the film is still radial direction. However, when the external magnetic field is applied to one side or both sides of the films during the same deposition conditions, the lattice distance (d111) in the (111) direction is expanded from 6.204 Å to 6.208 Å or 6.244 Å, respectively. As the lattice parameters are increased normal to the film plane by application of the magnetic field, the magnetic easy axis is converted from the radial direction to the circumferential direction and the Hₖ dramatically increases above 50 Oe.

As the result, the combined effects of directional atomic pair ordering and magneto-elastic energy of the Ni (40-50 at. %)—Fe alloy films induces a large magnetic anisotropy field of more than 50 Oe which is larger than that obtained in previous work (as low as 10 Oe).

The sputtering pressure and externally applied rotational magnetic field during the deposition of the NiFe films are the important factors in enhancing the magnetic anisotropy field in the films. To further investigate how film thickness affects the Hk the film, experiments controlling three factors (sputtering power, film thickness and bias voltage), at two levels (low and high) and a center point have been designed as shown in FIG. 6. The factors and levels are as follows,

Sputtering Power: Low (750 W) and High (1250 W)
Film thickness: Low (91 nm) and High (272 nm)
Bias voltage: Low (50 V) and High (150 V)
Center point: (1000 W, 182 nm and 100 V)

Table 1 shows the experimental parameters for the sputtering deposition conditions in Ni (40-50 at. %)—Fe alloy films, based on DOE (Design Of Experiment) shown in FIG. 6. The sputtering rate of the film at 6 mTorr was 6.05 (nm/kW sec). The film thickness was estimated by the sputtering power and sputtering deposition time.

TABLE 1

| | A: NiFe(45-55) (6.05 nm/kW sec) | | | | |
|---|---|---|---|---|---|
| | Time | | | | Thickness |
| No. | (Sec) | Power (W) | Pressure (mTorr) | DC bias (V) | (nm) |
| 1 | 20 | 750 | 60 | 50 | 91 |
| 2 | 12 | 1250 | | | 91 |
| 3 | 20 | 750 | | 150 | 91 |
| 4 | 12 | 1250 | | | 91 |
| 5 | 30 | 1000 | | 100 | 182 |
| 6 | | | | | 182 |
| 7 | 60 | 750 | | 50 | 272 |
| 8 | 36 | 1250 | | | 272 |
| 9 | 60 | 750 | | 150 | 272 |
| 10 | 36 | 1250 | | | 272 |

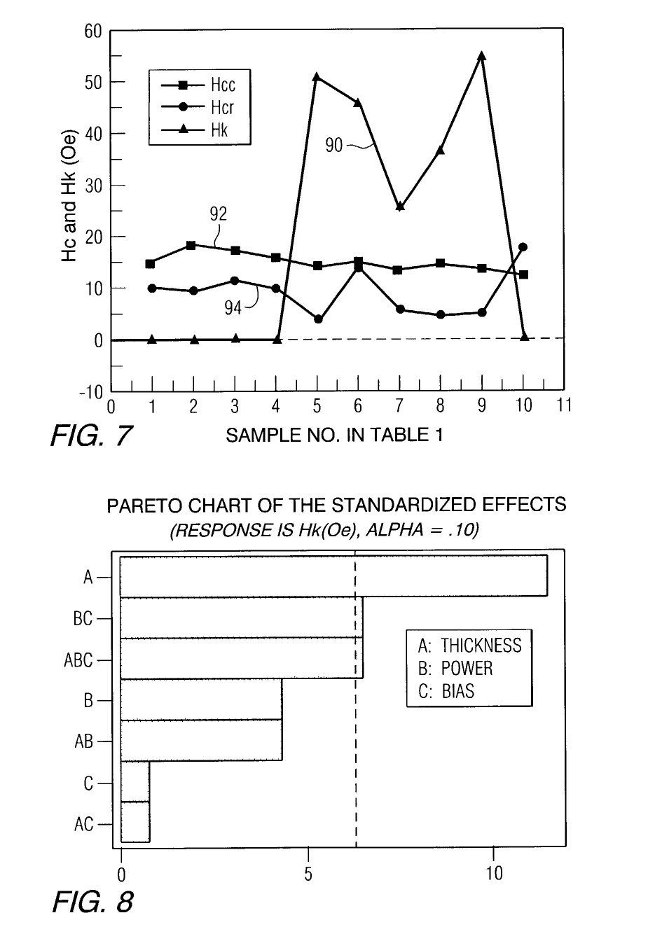

FIG. 7 is a graph showing the magnetic anisotropy field (Hₖ), circumferential coercivity (H_{cc}) and radial coercivity (H_{cr}) of Ni (40-50 at. %)—Fe alloy films in terms of several deposition runs. In FIG. 7 the data on line 90 represents the magnetic anisotropy field (Hₖ), the data on line 92 represents the circumferential coercivity (H_{cc}) and the data on line 94 represents the radial coercivity (H_{cr}) of Ni (40-50 at. %)—Fe alloy films in terms of deposition runs shown in Table 1.

FIG. 8 shows a statistical analysis of main and interaction effects on magnetic anisotropy field (Hₖ) in Ni (40-50 at. %)—Fe alloy films in terms of film thickness, sputtering power and bias voltage.

To interpret the main and interaction effects on Hₖ as the function of the film thickness, sputtering power and bias voltage, an analysis was conducted as shown in FIG. 8. In the statistical analysis, the film thickness and sputtering power have major and minor main effects, respectively on Hₖ. However, the bias voltage has a smaller effect on Hₖ than other factors. In terms of the interaction effect on Hₖ, the combination of sputtering power and bias voltage, as well as of film thickness, sputtering power and bias voltage show a major effect on Hₖ in the NiFe films. The interaction effect of film thickness and sputtering power, and film thickness and bias voltage on Hₖ can be neglected. The horizontal axis in FIG. 8 is marked in arbitrary units.

For confirmation of the statistical analysis, the main effect terms, such as sputtering power, bias voltage and the film thickness on Hₖ have been investigated by the deposition of the NiFe films.

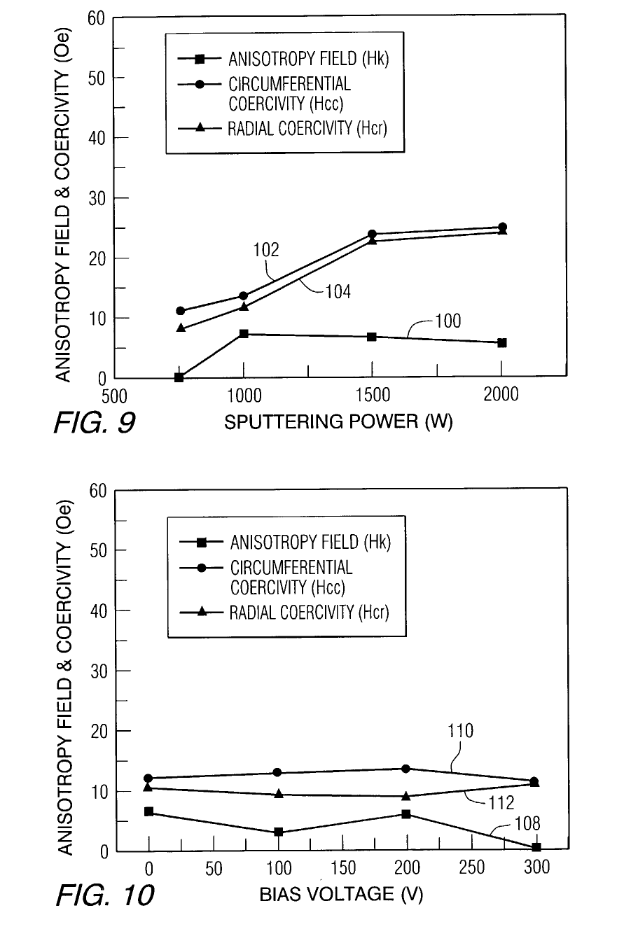

FIG. 9 is a graph showing the sputtering power effect on magnetic anisotropy field (Hₖ), circumferential coercivity (H_{cc}) and radial coercivity (H_{cr}) in Ni (40-50 at. %)—Fe alloy films. In FIG. 9, the data on line 100 represents the magnetic anisotropy field (Hₖ), the data on line 102 represents the circumferential coercivity (H_{cc}) and the data on line 104 represents the radial coercivity (H_{cr}) in Ni (40-50 at. %)—Fe alloy films. A sputtering power of around 1000 W shows the maximum Hₖ in the films with no distinct variation with changes in sputtering power. So it is reasonable to regard the sputtering power as having a minor effect on Hₖ in the statistic analysis in FIG. 8.

FIG. 10 is a graph showing the effect of bias voltage on magnetic anisotropy field (Hₖ), circumferential coercivity (H_{cc}) and radial coercivity (H_{cr}) in Ni (40-50 at. %)—Fe alloy films deposited under the externally applied rotational magnetic field while the sputtering power is 1000 W. In FIG. 10, the data on line 108 represents the anisotropy field (Hₖ), the data on line 110 represents the circumferential coercivity (H_{cc}) and the data on line 112 represents the radial coercivity (H_{cr}). The bias voltage has only a minimal effect on Hₖ which is less than 10 Oe. Thus the prediction of the bias voltage effect on Hₖ is good agreement with the statistic analysis.

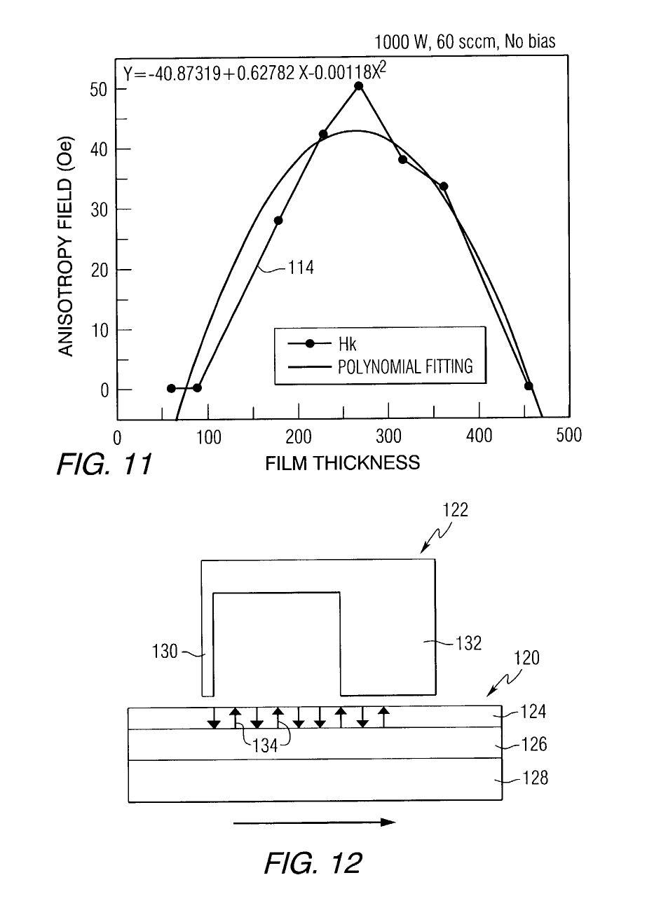

FIG. 11 is a graph showing the magnetic anisotropy field (Hₖ) in Ni (40-50 at. %)—Fe alloy films as the function of the film thickness for alloy films deposited under the externally applied rotational magnetic field at 6 mTorr, 1000 W and no bias voltage. In FIG. 11, the data on line 114 represents the anisotropy field (Hₖ). The film thickness significantly affects the changes of Hₖ in the films, which was regarded as the major main effect on Hₖ in the previous statistic analysis. The energy product of the magnets can be in the range of 20 to 30 MGOe.

The experiment results in FIG. 9, FIG. 10 and FIG. 11 confirm that the statistic analysis of the main effects on Hₖ agrees with the measured results.

FIG. 12 is a cross-section of a portion of a magnetic storage medium 120 constructed in accordance with the invention, in combination with a perpendicular recording head 122. The storage medium includes a magnetically hard layer 124 on a surface of a soft underlayer 126, which is supported by a substrate 128. Suitable hard magnetic materials for the hard magnetic recording layer 124 may include, for example, CoCr, FePd, FePt, CoPd, CoFePd, CoCrPt, or CoCrPd. The substrate 128 can comprise a material selected from the group of glass, MgO, silicon, and aluminum alloys.

The recording head includes a write pole 130 and a return pole 132. A magnetic field produced at the write pole changes the magnetization of sections of the magnetically hard layer as illustrated by arrows 134. The soft underlayer is a NiFe film that was deposited on the substrate under a magnetic field as described above.

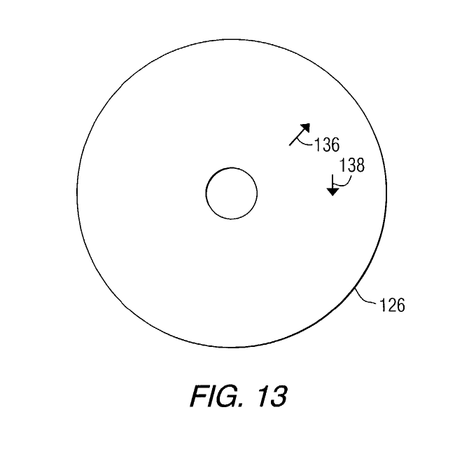

FIG. 13 is a plan view of a portion of the soft underlayer 126 of the storage medium of FIG. 12 constructed in accordance with the invention. Arrow 136 shows the radial direction and arrow 138 shows the circumferential direction. Films constructed in accordance with this invention have an easy axis of magnetization in the circumferential direction and a hard axis of magnetization in the radial direction.

Transition noise problem in perpendicular magnetic recording caused by a soft underlayer film can be suppressed by increasing the magnetic anisotropy field (Hₖ) in a Ni (40-50 at. %)—Fe alloy film with a finite magnetostriction constant. To create a large Hₖ on the surface of the film, magnetic anisotropy energy of the film should be preferred in the circumferential direction, compared to that in the radial direction. In the NiFe film, the interaction effect between an externally applied rotational magnetic field and sputtering pressure shows a dramatic increase of Hₖ (more than 50 Oe), which is attributed to the combination of the directional atomic pair orderings and magneto-elastic anisotropy energy. At optimized sputtering pressure and magnetic fields, the major parameters affecting Hₖ are the NiFe film thickness, and a combination of the film thickness, sputtering power and bias voltage, respectively.

While the present invention has been described in terms of several examples, it will be apparent to those skilled in the art that various changes can be made to the disclosed examples without departing from the scope of the invention as defined by the following claims.

What is claimed is:

1. A method of fabricating anisotropic magnetic films, the method comprising:
providing a substrate;
sputtering a layer of NiₓFe_{y} (where x ranges from 40 to 50 and y =(100-x)) onto a surface of the substrate; and
subjecting the layer of NiₓFe_{y} to a rotating magnetic field during the sputtering deposition process.

2. The method of claim 1, wherein the rotating magnetic field is produced by magnets having an energy product in the range of 20 to 30 MGOe.

3. The method of claim 1, wherein the layer of NiₓFe_{y} has a magnetostriction constant in the ranges of 5×10⁻⁶ to 25×10⁻⁶.

4. The method of claim 1, wherein the step of sputtering a layer of NiₓFe_{y} (where x ranges from 40 to 50 and y=(100-x)) onto a surface of the substrate uses a sputtering pressure in the range of 3 to 8 mTorr.

5. The method of claim 1, wherein the layer of NiₓFe_{y} has a thickness in the range of 200-400 nm.

6. The method of claim 1, wherein the step of subjecting the layer of NiₓFe_{y} to a rotating magnetic field during the sputtering step comprises:
positioning a first magnet above the layer of NiₓFe_{y} and rotating the first magnet during the sputtering step.

7. The method of claim 6, wherein the step of subjecting the layer of NiₓFe_{y} to a rotating magnetic field during the sputtering step further comprises:
positioning a second magnet below the layer of NiₓFe_{y} and rotating the second magnet during the sputtering step.

8. The method of claim 1, further comprising:
controlling the sputtering power and thickness of the layer of NiₓFe_{y} to control the magnetic anisotropy of the layer of NiₓFe_{y}.

9. The method of claim 1, wherein the substrate comprises a material selected from the group of:
glass, MgO, silicon, and aluminum alloys.

10. A magnetic storage medium comprising:
a substrate;
a soft magnetic underlayer supported by the substrate, the soft magnetic underlayer including NiₓFe_{y} (where x ranges from 40 to 50 and y=(100-x)) and having an easy axis in a circumferential direction and a hard axis in a radial direction; and
a magnetically hard layer supported by the soft magnetic underlayer.

11. The magnetic storage medium of claim 10, wherein the soft magnetic underlayer has a magnetic anisotropy of greater than 50 Oe.

12. The magnetic storage medium of claim 10, wherein the layer of NiₓFe_{y} has a magnetostriction constant in the ranges of 5×10⁻⁶ to 25×10⁻⁶.

13. The magnetic storage medium of claim 10, wherein the layer of NiₓFe_{y} has a thickness in the range of 200-400 nm.

14. The magnetic storage medium of claim 10, wherein the substrate comprises a material selected form the group of:
glass, MgO, silicon, and aluminum alloys.

15. The magnetic storage medium of claim 10, wherein the magnetically hard layer comprises a material selected from the group of:
CoCr, FePd, FePt, CoPd, CoFePd, CoCrPt, and CoCrPd.
